(19) United States
(12) Patent Application Publication
(10) Pub. No.: US 2012/0287504 A1
(43) Pub. Date: Nov. 15, 2012

(54) IMAGE DISPLAY DEVICE

(75) Inventors: Ju-Hoon JANG, Seoul (KR); Hyeon-Ho Son, Gyeonggi-do (KR); Jin-Yeong Kim, Gyeonggi-do (KR); Hee-Young Chae, Gyeonggi-do (KR); Seung-Man Ryu, Gyeonggi-do (KR)

(73) Assignee: LG Display Co., Ltd.

(21) Appl. No.: 13/297,407

(22) Filed: Nov. 16, 2011

(30) Foreign Application Priority Data
May 12, 2011 (KR) 10-2011-0044444

(51) Int. Cl. G02B 27/26

(52) U.S. Cl. 359/463

(57) ABSTRACT

An image display device includes a display panel including left-eye horizontal pixel lines displaying a left-eye image and right-eye horizontal pixel lines displaying a right-eye image; a polarizing film disposed over the display panel and linearly polarizing the left-eye image and the right-eye image; a patterned retarder disposed over the polarizing film and including left-eye retarders and right-eye retarders; and a lenticular lens film disposed over the polarizing film and including lenticular lenses, wherein the lenticular lenses correspond to the left-eye retarders and the right-eye retarders, respectively, wherein the lenticular lenses are spaced part from each other.

This application claims the benefit of Korean Patent Application No. 10-2011-0044444 filed in Korea on May 12, 2011, which is hereby incorporated by reference for all purposes as if fully set forth herein.

### BACKGROUND OF THE INVENTION

1. Field of the Invention

The invention relates to a display device, and more particularly, to an image display device with a lenticular lens film that has an improved viewing angle and brightness.

2. Discussion of the Related Art

Human beings perceive a depth and a three-dimensional effect due to psychological and memorial factors in addition to a binocular disparity from a separation distance of eyes. From theses, three-dimensional image display devices are classified into a holographic type, a stereographic type, and a volumetric type depending on the extent of three-dimensional image information provided to the viewer.

The volumetric type, in which perspective along a depth direction is perceived due to psychological factors and inhalation effects, is used for three-dimensional computer graphics of calculating and displaying perspective, superposition, shade and shadow, light and darkness, motion, and so on, or I-MAX movies of causing an optical illusion in which the viewer is provided with a large screen having wide viewing angles and seems to be sucked into the space.

The holographic type, which is the most perfect three-dimensional image display technology, is used for a holographic image using a laser or a white ray.

The stereographic type uses a physiological factor of both eyes to perceive the three-dimensional effect. More particularly, the stereographic type uses stereography in which, when linked two-dimensional images including parallax information are provided to left- and right-eyes spaced apart from each other with a distance of about 65 mm, a brain produces space information about the front and the rear of the screen during merging them and thus perceives the three-dimensional effect.

The stereographic type may be referred to as a multi-view image display type. The stereographic type may be classified into a glasses type, where the user wears specific glasses, and a glasses-free type, in which a parallax barrier or a lens array such as lenticular or integral is used at a display side, depending a position in which a substantial three-dimensional effect is produced.

The glasses type has wider viewing angles and causes less dizziness than the glasses-free type. In addition, the glasses type can be manufactured with relatively low costs, and, specially, the glasses type can be manufactured with very low costs as compared with the hologram type. Moreover, in the glasses type, since the viewer wears the glasses to watch three-dimensional stereoscopic images and does not wear the glasses to watch two-dimensional images, there is an advantage that one display device can be used for displaying both two-dimensional images and three-dimensional stereoscopic images.

The glasses type may be classified into a shutter glasses type and a polarization glasses type. In the shutter glasses type, left- and right-eye images are alternately displayed in a screen, sequential opening and closing timing of a left shutter and a right-shutter of the shutter glasses is accorded with alternation time of the left- and right-eye images, and the respective images are separately perceived by the left eye and the right eye, thereby producing the three-dimensional effect.

In the polarization glasses type, pixels of a screen are divided into two by columns, rows or pixels, left- and right-eye images are displayed in different polarization directions, the left-glass and the right-glass of the polarization glasses have different polarization directions, and the respective images are separately perceived by the left eye and the right eye, thereby producing the three-dimensional effect.

The shutter glasses type needs to increase alternation numbers per unit time in order to reduce fatigue and improve the three-dimensional effect. By the way, when a liquid crystal display device is used for the shutter glasses type, liquid crystal has slow response time, and screen addressing timing of a scan type is not completely accorded with the alternation timing of the images. Thus, flicker may occur, and this may cause fatigue such as dizziness while watching the images.

On the other hand, the polarization glasses type does not have factors of causing flicker, and fatigue is less caused while watching the images. The polarization glasses type may cause a reduction by half in monocular resolution because the pixels of the screen are divided into two by columns, rows or pixels. However, since current display panels have high resolution and it is possible to further increase the resolution in the future, the reduction by half in monocular resolution of the polarization glasses type is not a problem.

In addition, the shutter glasses type should have hardware or circuits in the display device for alternation display and needs expensive shutter glasses. Costs are raised as viewers are increased. On the other hand, the polarization glasses type can use a polarization dividing optical member, which is patterned to divide polarized light, for example, a patterned retarder or a micro polarizer, on a front surface of a display panel, and at this time, the viewer can wear polarization glasses, which are very cheaper than the shutter glasses, to watch it. Accordingly, costs of the polarization glasses type are relatively low.

The three-dimensional image display device includes a flat panel display such as a liquid crystal panel or an organic electroluminescent panel as a display panel.

FIG. 1 is a perspective view of illustrating a polarized glasses-type three-dimensional image display device according to the related art.

In FIG. 1, the polarized glasses-type three-dimensional image display device 10 according to the related art includes a display panel 20 displaying an image, a polarizing film 50 over the display panel 20, and a patterned retarder 60 over the polarizing film 50.

The display panel 20 includes display areas DA substantially displaying the image and non-display areas NDA between adjacent display areas DA. The display areas DA include left-eye horizontal pixel lines Hl and right-eye horizontal pixel lines Hr.

The left-eye horizontal pixel lines Hl displaying a left-eye image and the right-eye horizontal pixel lines Hr displaying a right-eye image are alternately arranged along a vertical direction of the display panel 20 in the context of the figure. Red, green and blue sub-pixels R, G and B are sequentially arranged in each of the left-eye horizontal pixel lines Hl and the right-eye horizontal pixel lines Hr.

The polarizing film 50 changes the left-eye image and the right-eye image displayed by the display panel 20 into a linearly-polarized left-eye image and a linearly-polarized right-eye image, respectively, and transmits the linearly-polarized left-eye image and the linearly-polarized right-eye image to the patterned retarder 60.

The patterned retarder 60 includes left-eye retarders Rl and right-eye retarders Rr. The left-eye retarders Rl and the right-eye retarders Rr correspond to the left-eye horizontal pixel lines Hl and the right-eye horizontal pixel lines Hr, respectively, and are alternately arranged along the vertical direction of the display panel 20 in the context of the figure. The left-eye retarders Rl change linearly-polarized light into left-circularly polarized light, and the right-eye retarders Rr change linearly-polarized light into right-circularly polarized light.

Therefore, a left-eye image displayed by the left-eye horizontal pixel lines Hl of the display panel 20 is linearly polarized when passing through the polarizing film 50, is left-circularly polarized when passing through the left-eye retarders Rl of the patterned retarder 60, and is transmitted to the viewer. A right-eye image displayed by the right-eye horizontal pixel lines Hr of the display panel 20 is linearly polarized when passing through the polarizing film 50, is right-circularly polarized when passing through the right-eye retarders Rr of the patterned retarder 60, and is transmitted to the viewer.

Polarized glasses 80 which the viewer wears include a left-eye lens 82 and a right-eye lens 84. The left-eye lens 82 transmits only left-circularly polarized light, and the right-eye lens 84 transmits only right-circularly polarized light.

Accordingly, among the images transmitted to the viewer, the left-circularly polarized left-eye image is transmitted to the left-eye of the viewer through the left-eye lens 82, and the right-circularly polarized right-eye image is transmitted to the right-eye of the viewer through the right-eye lens 84. The viewer combines the left-eye image and the right-eye image respectively transmitted to the left-eye and the right-eye and realizes a three-dimensional stereoscopic image.

FIG. 2 is a cross-sectional view of a polarized glasses-type three-dimensional image display device according to the related art, which includes a liquid crystal display panel as a display panel.

In FIG. 2, a display panel 20 includes first and second substrates 22 and 40 facing and spaced apart from each other and a liquid crystal layer 48 interposed between the first and second substrates 22 and 40.

A gate line (not shown) and a gate electrode 24 connected to the gate line are formed on an inner surface of the first substrate 22. A gate insulating layer 26 is formed on the gate line and the gate electrode 24.

A semiconductor layer 28 is formed on the gate insulating layer 26 corresponding to the gate electrode 24. Source and drain electrodes 32 and 34 spaced apart from each other and a data line (not shown) connected to the source electrode 32 are formed on the semiconductor layer 28. The data line crosses the gate line to define a pixel region.

Here, the gate electrode 24, the semiconductor layer 28, the source electrode 32 and the drain electrode 34 form a thin film transistor T.

A passivation layer 36 is formed on the source electrode 32, the drain electrode 34 and the data line, and the passivation layer 36 has a drain contact hole 36a exposing the drain electrode 34.

A pixel electrode 38 is formed on the passivation layer 36 in the pixel region and is connected to the drain electrode 34 through the drain contact hole 36a.

A black matrix 42 is formed on an inner surface of the second substrate 40. The black matrix 42 has an opening corresponding to the pixel region and corresponds to the gate line, the data line and the thin film transistor T. A color filter layer 44 is formed on the black matrix 42 and on the inner surface of the second substrate 40 exposed through the opening of the black matrix 42. Although not shown in the figure, the color filter layer 44 includes red, green and blue color filters, each of which corresponds to one pixel region.

A transparent common electrode 46 is formed on the color filter layer 44.

The liquid crystal layer 48 is disposed between the pixel electrode 38 of the first substrate 22 and the common electrode 46 of the second substrate 40. Although not shown in the figure, alignment layers, which determine initial arrangements of liquid crystal molecules, are formed between the liquid crystal layer 48 and the pixel electrode 38 and between the liquid crystal layer 48 and the common electrode 46, respectively.

Meanwhile, a first polarizer 52 is disposed on an outer surface of the first substrate 22, and a second polarizer 50 is disposed on an outer surface of the second substrate 40. The second substrate 50 corresponds to the polarizing film of FIG. 1. The first and second polarizers 52 and 50 transmit linearly polarized light, which is parallel to their transmission axes. The transmission axis of the first polarizer 52 is perpendicular to the transmission axis of the second polarizer 50.

A patterned retarder 60 is attached on the second polarizer 50. The patterned retarder 60 includes a base film 62, a retarder layer 64, a black stripe 66 and an adhesive layer 68.

The retarder layer 64 includes left-eye retarders Rl and right-eye retarders Rr, which are alternately arranged along a vertical direction of the device. The black stripe 66 corresponds to borders between the left-eye retarders Rl and the right-eye retarders Rr.

The left-eye retarders Rl and the right-eye retarders Rr have a retardation value of λ/4, and their optical axes make angles of +45 degrees and −45 degrees with respect to a polarized direction of the linearly polarized light transmitted from display panel 20 and the second polarizer 50.

The black stripe 66 prevents three dimensional (3D) crosstalk where the left-eye and right-eye images are simultaneously transmitted to the left-eye or the right-eye of the viewer, thereby improving 3D viewing angles along the up and down direction of the device.

Alternatively, to prevent the 3D crosstalk, the black matrix 42 in the display device may have a widened width instead of forming the black stripe 66.

An improvement in the 3D crosstalk and the 3D viewing angles using the black stripe or black matrix will be explained with reference to accompanying drawings.

FIGS. 3A to 3C are schematic cross-sectional views of showing 3D crosstalk in the related art polarized glasses-type three-dimensional image display device. FIG. 3A shows the device without the black stripe, FIG. 3B shows the device with the black stripe, and FIG. 3C the device with the black matrix having the widened width instead of the black stripe.

Although not shown in the figures, at the front viewing angle and the left and right viewing angles of the polarized glasses-type three-dimensional image display device 10, the left-eye image Il displayed by the left-eye horizontal pixel lines Hl of the display panel 20 is left-circularly polarized when passing through the left-eye retarders Rl of the patterned retarder 60 and is transmitted the viewer, and the right-eye image Ir displayed by the right-eye horizontal pixel lines Hr of the display panel 20 is right-circularly polarized when passing through the right-eye retarders Rr of the patterned retarder 60 and is transmitted to the viewer. Thus, there is no 3D crosstalk due to mixing of the left-eye image Il and the right-eye image Ir.

However, as shown in FIG. 3A, at the up and down viewing angles of the polarized glasses-type three-dimensional image display device 10, some of the left-eye image Il displayed by the left-eye horizontal pixel lines Hl of the display panel 20 passes through the right-eye retarder Rr of the patterned retarder 60 and is right-circularly polarized.

Namely, the right-eye image Ir and some of the left-eye image Il are right-circularly polarized and are transmitted to the right-eye of the viewer through the right-eye lens 84 of the polarized glasses 80. Therefore, the right-eye image Ir and some of the left-eye image Il interfere with each other, and 3D crosstalk occurs. The 3D viewing angle properties along the up and down direction are lowered.

The interference in the left-eye image Il and the right-eye image Ir may be decreased due to the non-display areas NDA between the display areas DA having a first height h1 of the display panel 20. Since the display panel 20 is rather far from the patterned retarder 60, the effect for preventing the 3D crosstalk is insignificant.

To improve this, as shown in FIG. 3B, the black stripe 66 may be formed between the left-eye retarder Rl and the right-eye retarder Rr of the patterned retarder 60, or as shown in FIG. 3C, the black matrix 43 in the display panel 20 may have the widened width without the black stripe.

Here, some of the left-eye image Il, which is displayed by the left-eye horizontal pixel lines Hl of the display panel 20 and proceeds to the right-eye retarder Rr of the patterned retarder 60, is blocked by the black stripe 66 or the black matrix 43. Thus, some of the left-eye image Il is not right-circularly polarized and is not outputted.

That is to say, only the right-eye image Ir is right-circularly polarized and is transmitted to the right-eye of the viewer through the right-eye lens 84 of the polarized glasses 80. The 3D crosstalk due to the interference of the right-eye image Ir and some of the left-eye image Il is prevented, and the 3D viewing angle properties along the up and down direction are improved.

However, the display panel 20 includes a black stripe area BS, which is larger than the non-display area NDA, due to the black stripe 66, and the display area DA is substantially decreased to have a second height h2 smaller than the first height h1. Or, the non-display area NDA is increased due to the black matrix 43, and the display area DA is decreased to have a third height h3 smaller than the first height h1. Accordingly, the aperture ratio and the brightness are decreased.

Meanwhile, as shown in FIG. 4A, to improve the 3D crosstalk, another method of forming a lenticular lens film 70 on the patterned retarder 60 has been suggested.

The lenticular lens film 70, for example, makes the left-eye image, some of which passes through the right-eye retarder Rr, turn toward other directions and prevents the 3D cross-talk.

Here, a lens pitch P_{L} of the lenticular lens film 70, which is defined as a width of each lenticular lens 74, is larger than or equal to a pixel pitch P_{P} of the display panel 20, which is defined as a distance from an upper end of a pixel to an upper end of a next pixel along the vertical direction of the display panel 20 in the context of the figure.

At this time, an attaching process of the lenticular lens film 70 and the display panel 20 is performed such that the lens pitch and the pixel pitch may be matched to each other generally with respect to central portions of the lenticular lens film 70 and the display panel 20.

When the lenticular lens film 70 is accurately attached, some of the left-eye image, which is displayed by the left-eye horizontal pixel lines Hl and passes through the right-eye retarder Rr, is refracted with a further exterior angle and is not transmitted to the viewer. Thus, the 3D cross-talk is prevented.

However, in a practical attaching process, it is hard to accurately attach the lenticular lens film 70 and the display panel 20 with respect to their central portions. Therefore, as shown in FIG. 4B, each lenticular lens 74 is not accurately attached to and is attached away from the corresponding left-eye retarder Rl or right-eye retarder Rr. The lenticular lens 74 is aligned to the corresponding left-eye retarder Rl or right-eye retarder Rr with an error.

Thus, some of the left-eye image, which is displayed by the left-eye horizontal pixel lines Hl and passes through the right-eye retarder Rr, passes through the lenticular lens 74 attached away from the left-eye retarder Rl, that is, a misaligned portion PT, and comes out to the front, thereby being transmitted to the viewer. Namely, the crosstalk occurs at the front, which may be referred to as a front crosstalk. The front crosstalk increases as compared with the case that the lenticular lens film 70 is accurately attached to the patterned retarder 60.

An increasing rate of the front crosstalk depends on the attaching error of the lenticular lens film 70 and the patterned retarder 60. For example, when the attaching error is 2.5 micrometers, the increasing rate of the front crosstalk is about 0.5%. Therefore, the front crosstalk increases by about 5% due to the error generated in the practical attaching process.

FIG. 4C is a view of showing simulation results of front crosstalk when the lenticular lens is attached away from the patterned retarder according to the related art.

In FIG. 4C, some of the left-eye image displayed by the left-eye horizontal pixel lines Hl and passing through the right-eye retarder Rr passes through the lenticular lens 74 in the misaligned portion PT, is concentrated, and comes out to the front, thereby being transmitted to the viewer.

Namely, even though the lenticular lens film 70 is used to improve the 3D crosstalk, there might be an error because it is hard to accurately attach the lenticular lens film 70 to the patterned retarder 60. In addition, there is a problem that the front crosstalk increases by about 5% due to the error, which may generally occur.

### SUMMARY OF THE INVENTION

Accordingly, the present invention is directed to a three-dimensional image display device that substantially obviates one or more of the problems due to limitations and disadvantages of the related art.

An object of the present invention is to provide to a three-dimensional image display device that improves 3D viewing angle properties and increases the aperture ratio and the brightness by preventing the 3D crosstalk.

Another object of the present invention is to provide a three-dimensional image display device that improves the front crosstalk due to the misalignment of the lenticular lens film.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of embodiments of the invention, as embodied and broadly described, an image display device includes a display panel including left-eye horizontal pixel lines displaying a left-eye image and right-eye horizontal pixel lines displaying a right-eye image; a polarizing film disposed over the display panel, wherein the polarizing film linearly polarizes the left-eye image and the right-eye image; a patterned retarder disposed over the polarizing film and including left-eye retarders and right-eye retarders; and a lenticular lens film disposed over the polarizing film and including lenticular lenses, wherein the lenticular lenses correspond to the left-eye retarders and the right-eye retarders, respectively, wherein the lenticular lenses are spaced part from each other.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a perspective view of illustrating a polarized glasses-type three-dimensional image display device according to the related art;

FIG. 2 is a cross-sectional view of a polarized glasses-type three-dimensional image display device according to the related art;

FIGS. 3A to 3C are schematic cross-sectional views of showing 3D crosstalk in the related art polarized glasses-type three-dimensional image display device;

FIGS. 4A to 4C are views of schematically showing the front crosstalk increasing due to the attaching error when the lenticular lens is larger than or equal to the pixel pitch.

FIG. 5 is a perspective view of illustrating a polarized glasses-type three-dimensional image display device according to an exemplary embodiment of the present invention;

FIG. 6 is a cross-sectional view of illustrating a three-dimensional image display device according to an exemplary embodiment of the present invention;

FIG. 7 is a schematic view of showing front 3D crosstalk in a three-dimensional image display device according to an exemplary embodiment of the present invention; and

FIG. 8 is a view of showing simulation results of light coming out when the lens pitch is smaller than the pixel pitch.

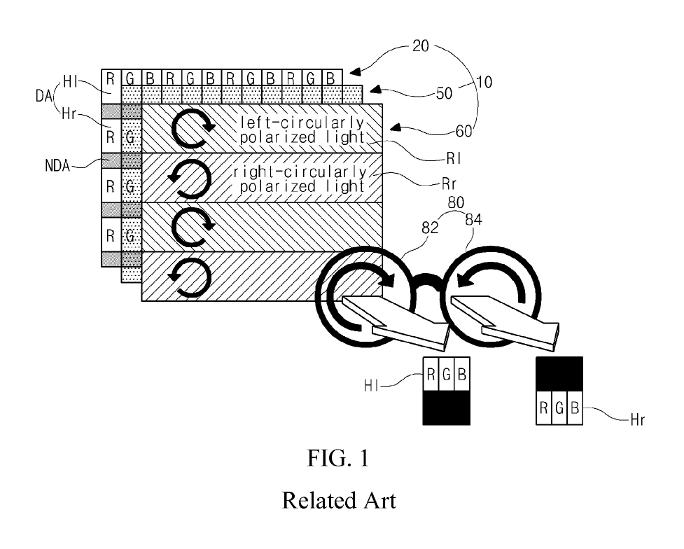

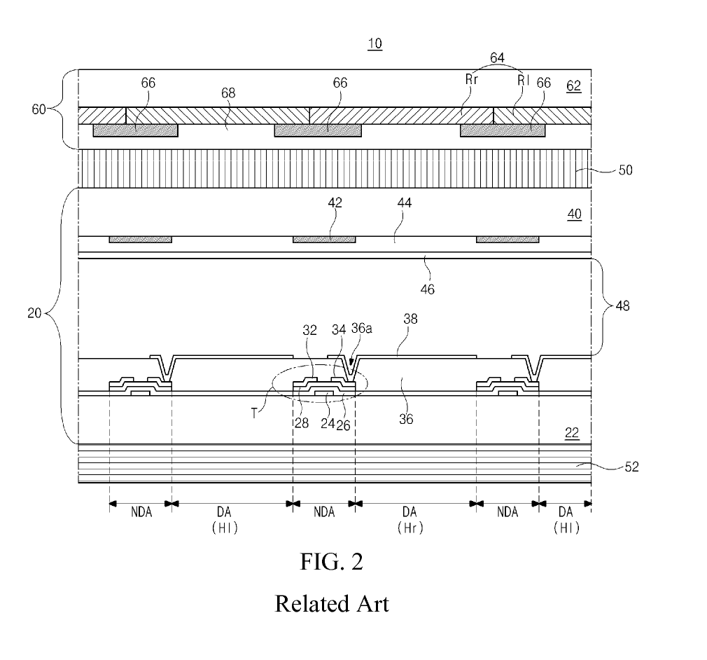

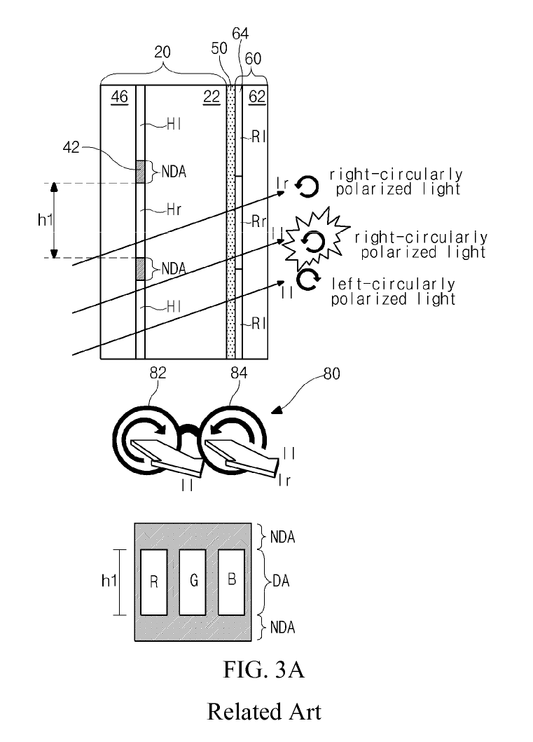

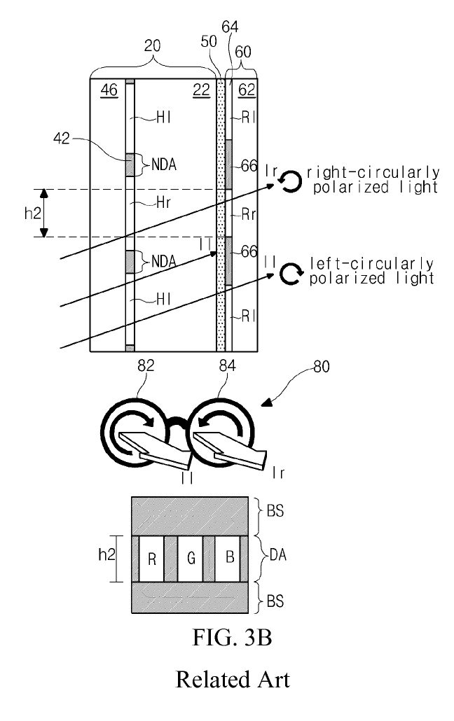

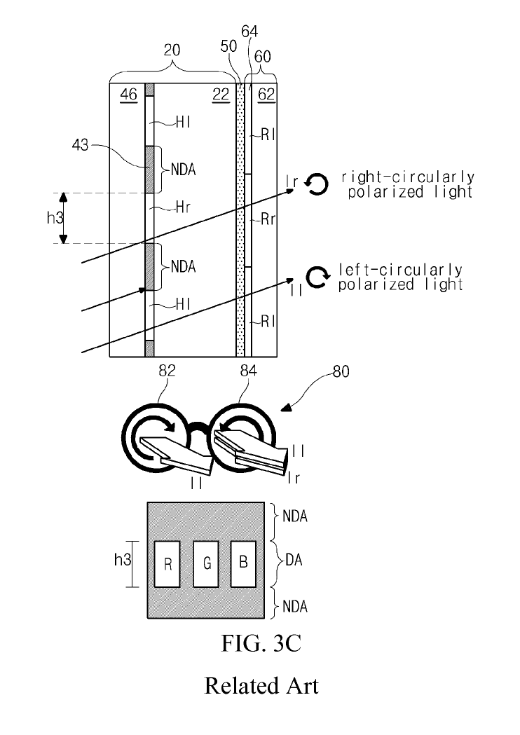

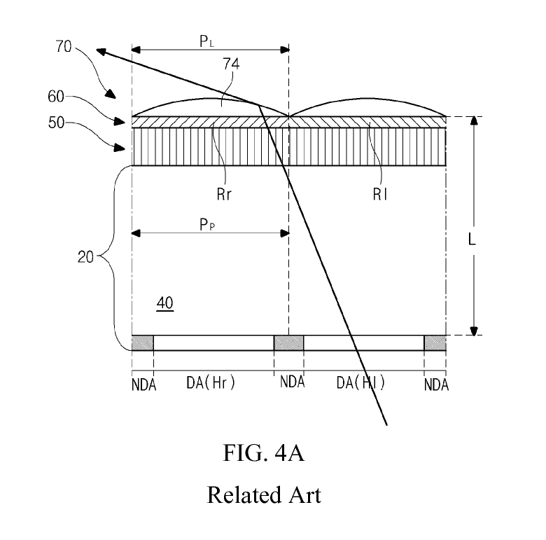

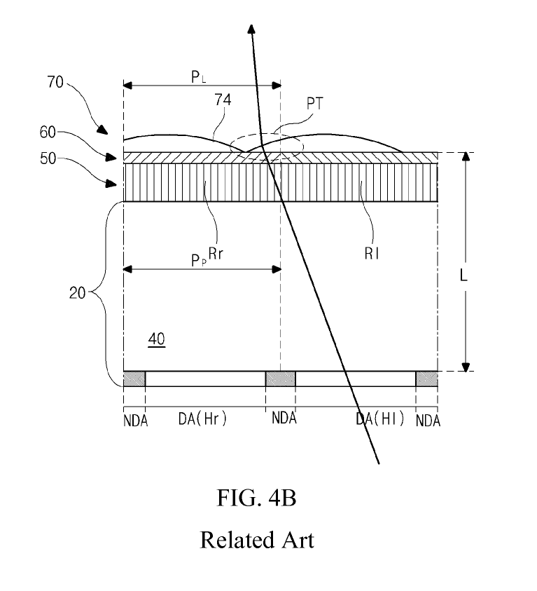

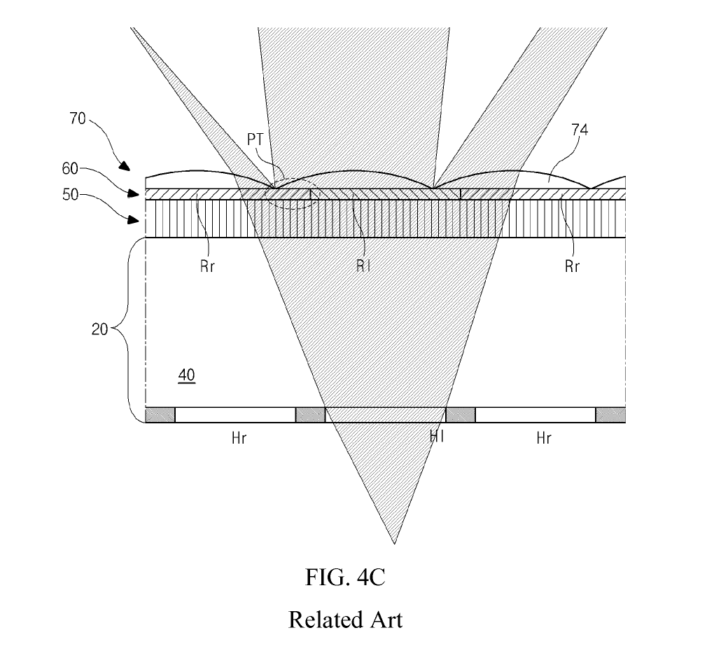

### DETAILED DESCRIPTION OF EXEMPLARY EMBODIMENTS

Reference will now be made in detail to exemplary embodiments of the invention, which are illustrated in the accompanying drawings.

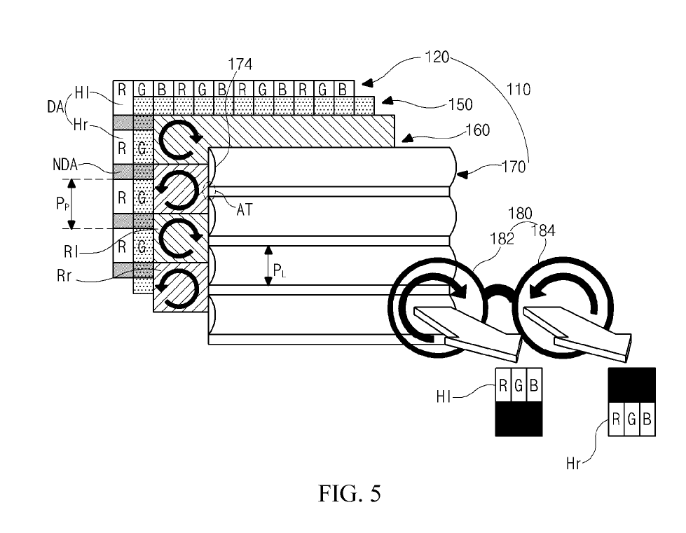

FIG. 5 is a perspective view of illustrating a polarized glasses-type three-dimensional image display device according to an exemplary embodiment of the present invention.

In FIG. 5, the polarized glasses-type three-dimensional image display device 110 of the present invention includes a display panel 120 displaying an image, a polarizing film 150 over the display panel 120, a patterned retarder 160 over the polarizing film 150, and a lenticular lens film 170 over the patterned retarder 160. Here, the lenticular lens film 170 may be a sheet shape.

The display panel 120 includes display areas DA substantially displaying the image and non-display areas NDA between adjacent display areas DA. The display areas DA include left-eye horizontal pixel lines Hl and right-eye horizontal pixel lines Hr.

The left-eye horizontal pixel lines Hl displaying a left-eye image and the right-eye horizontal pixel lines Hr displaying a right-eye image are alternately arranged along a vertical direction of the display panel 120 in the context of the figure. Red, green and blue sub-pixels R, G and B are sequentially arranged in each of the left-eye horizontal pixel lines Hl and the right-eye horizontal pixel lines Hr.

The polarizing film 150 changes the left-eye image and the right-eye image displayed by the display panel 120 into a linearly-polarized left-eye image and a linearly-polarized right-eye image, respectively, and transmits the linearly-polarized left-eye image and the linearly-polarized right-eye image to the patterned retarder 160.

The patterned retarder 160 includes left-eye retarders Rl and right-eye retarders Rr. The left-eye retarders Rl and the right-eye retarders Rr correspond to the left-eye horizontal pixel lines Hl and the right-eye horizontal pixel lines Hr, respectively, and are alternately arranged along the vertical direction of the display panel 120 in the context of the figure. The left-eye retarders Rl change linearly-polarized light into left-circularly polarized light, and the right-eye retarders Rr change linearly-polarized light into right-circularly polarized light.

The lenticular lens film 170 concentrates the left-circularly polarized light or the right-circularly polarized light from the patterned retarder 160 upon a predetermined direction and improves the viewing angles along the up and down direction of the device in the context of the figure. The lenticular lens film 170 includes a plurality of lenticular lenses 174 arranged along the vertical direction of the display panel 120 in the context of the figure. Each lenticular lens 174 corresponds to one of the left-eye retarders Rl or one of the right-eye retarders Rr.

Here, a lens pitch P_{L} of the lenticular lens film 170, which is defined as a width of each lenticular lens 174 is smaller than a pixel pitch P_{P} of the display panel 120, which is defined as a distance from an upper end of a pixel to an upper end of a next pixel along the vertical direction of the display panel 120 in the context of the figure. The lenticular lenses 174 have a space therebetween.

At this time, an attaching process of the lenticular lens film 170 and the display panel 120 is performed such that the lens pitch P_{L} and the pixel pitch P_{P} may be matched to each other generally with respect to central portions of the lenticular lens film 170 and the display panel 120. However, in a practical attaching process, it is hard to accurately attach the lenticular lens film 170 and the display panel 120 with respect to their central portions. Therefore, the lens pitch P_{L} is smaller than the pixel pitch P_{P} considering an error that occurs in the attaching process.

More particularly, if the lenticular lens film 170 is accurately attached, to most effectively improve the crosstalk, the lens pitch P_{L} may have a difference within a range of about ±5 μm from the pixel pitch P_{P}. Beneficially, the pixel pitch P_{P} may be smaller than or equal to the lens pitch P_{L}. That is, the lens pitch P_{L} may have an ideal value when each lenticular lens 174 is correctly aligned with the left-eye retarder Rl or the right-eye retarder Rr in a process of manufacturing the image display device 110.

However, it is difficult to correctly align the lenticular lens 174 with the left-eye retarder Rl or the right-eye retarder Rr in the process of manufacturing the image display device 110 because it is a superprecision operation. Thus, the front crosstalk may be worse due to an attaching error of the lenticular lens 174 and the patterned retarder 160 as compared with the case that the lenticular lens 174 is accurately attached to the patterned retarder 160.

Therefore, in the present invention, the lens pitch P_{L} is reduced by determining a attaching tolerance AT considering the ideal lens pitch P_{L}, which is the value when the lenticular lens 174 is accurately attached, and the attaching error. Namely, the lens pitch P_{L} is smaller than the pixel pitch P_{P}. Even though the error exists in the attaching process of the lenticular lens film 170, each lenticular lens 174 is disposed over the corresponding left-eye retarder Rl or the corresponding right-eye retarder Rr. In other words, the lenticular lenses 174 are disposed with a space therebetween. Thus, although the error exists in the attaching process of the lenticular lens film 170, each lenticular lens 174 is not disposed over a next left-eye retarder Rl or a next right-eye retarder Rr and is disposed over the corresponding left-eye retarder or the corresponding right-eye retarder Rr.

Accordingly, the lenticular lens film 170 is attached without a misalignment from the left-eye retarder Rl or the right-eye retarder Rr due to the attaching error, and the front crosstalk can be prevented.

Namely, the lens pitch P_{L} has a smaller value than the pixel pitch P_{P} by applying the attaching tolerance AT to the lens pitch P_{L}, and the lenticular lens film 170 can be stably attached to the patterned retarder 160 such that each lenticular lens 174 corresponds to the left-eye retarder Rl or the right-eye retarder Rr.

Here, an increasing rate of the front crosstalk according to the embodiment of the present invention is determined to have a smaller value than an increasing rate of the front crosstalk generated due to the attaching error, and there is an effect of substantially improving the front crosstalk.

The attaching tolerance AT may be obtained from equation (1).

attaching tolerance (AT)=increasing rate of applicable front crosstalk×pixel pitch (P_{P}) equation (1)

The increasing rate of the applicable front crosstalk is an increasing rate of the front crosstalk which is expected in comparison with the case that the lens pitch P_{L} is larger than or equal to the pixel pitch P_{P} and the lenticular lens film 170 is accurately attached.

In other words, it means the increasing rate of the front crosstalk which is expected to be increased as compared with the case that the lens pitch P_{L} has the ideal value stated above and the lenticular lens film 170 is attached to the patterned retarder 160 such that each lenticular lens 174 accurately corresponds to the left-eye retarder Rl or the right-eye retarder Rr.

In embodiment of the present invention, the attaching tolerance AT is calculated by intentionally applying the increasing rate of the front crosstalk that has a smaller value than the increasing rate of the front crosstalk generated due to the attaching error.

For example, when the increasing rate of the applicable front crosstalk is 3% and the pixel pitch P_{P} is 541 micrometers, the attaching tolerance AT is about 16 micrometers. Therefore, the lenticular lenses 174 are disposed with the space of about 16 micrometers therebetween.

Since the increasing rate of the applicable front crosstalk according to the embodiment of the present invention has the smaller value than the increasing rate of the front crosstalk generated due to the attaching error, there are substantially more effects in improving the front crosstalk than the lenticular lens film 170 having the ideal lens pitch P_{P}.

Therefore, a left-eye image displayed by the left-eye horizontal pixel lines Hl of the display panel 120 is linearly polarized when passing through the polarizing film 150, is left-circularly polarized when passing through the left-eye retarders Rl of the patterned retarder 160, and is put toward a first direction when passing through the lenticular lens film 170. A right-eye image displayed by the right-eye horizontal pixel lines Hr of the display panel 120 is linearly polarized when passing through the polarizing film 150, is right-circularly polarized when passing through the right-eye retarders Rr of the patterned retarder 160, and is put toward the first direction when passing through the lenticular lens film 170. Accordingly, the left-eye image and the right-eye image put toward the first direction are transmitted to the viewer.

Additionally, in the embodiment of the present invention, the increasing rate of the front crosstalk is intentionally increased and is smaller than the increasing rate of the front crosstalk generated due to the attaching error in the attaching process, and thus the quality of the image is substantially further improved.

Polarized glasses 180 which the viewer wears include a left-eye lens 182 and a right-eye lens 184. The left-eye lens 182 transmits only left-circularly polarized light, and the right-eye lens 184 transmits only right-circularly polarized light.

Accordingly, among the images transmitted to the viewer, the left-circularly polarized left-eye image is transmitted to the left-eye of the viewer through the left-eye lens 182, and the right-circularly polarized right-eye image is transmitted to the right-eye of the viewer through the right-eye lens 184. The viewer combines the left-eye image and the right-eye image respectively transmitted to the left-eye and the right-eye and realizes a three-dimensional stereoscopic image.

At this time, some of the left-eye image may be right-circularly polarized by passing through the right-eye retarders Rr of the patterned retarder 160, or some of the right-eye image may be left-circularly polarized by passing through the left-eye retarders Rl of the patterned retarder 160. However, the right-circularly polarized left-eye image or the left-circularly polarized right-eye image may be put toward a second direction different from the first direction when passing through the lenticular lens film 170.

More particularly, a focal length is controlled by a thickness of the lenticular lens 174. As the thickness of the lenticular lens 174 is thick, the focal length is short. In addition, the shorter the focal length is, the larger a refractive index of the lenticular lens 174 is. Therefore, the right-eye image passing through the left-eye retarder Rl is further refracted and is not transmitted to the viewer. Accordingly, the 3D crosstalk due to interference of the left-eye image and the right-eye image can be prevented, and the viewing angle properties can be improved.

Here, the front crosstalk may be partially generated. However, the front crosstalk is smaller than the front crosstalk generated due to the attaching error in the attaching process, and a substantially improved quality of the image is provided as stated above.

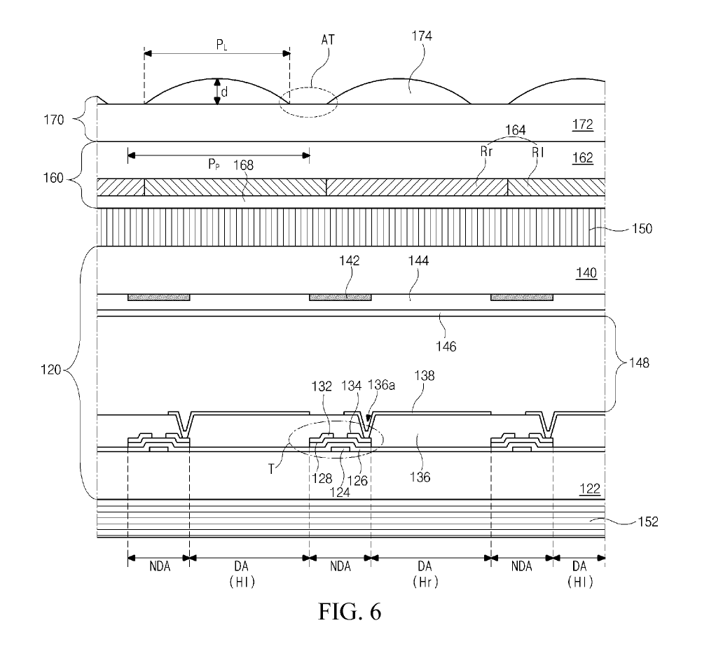

FIG. 6 is a cross-sectional view of illustrating a three-dimensional image display device according to an exemplary embodiment of the present invention.

In FIG. 6, a display panel 120 includes first and second substrates 122 and 140 facing and spaced apart from each other and a liquid crystal layer 148 interposed between the first and second substrates 122 and 140.

A gate line (not shown) and a gate electrode 124 connected to the gate line are formed on an inner surface of the first substrate 122. A gate insulating layer 126 is formed on the gate line and the gate electrode 124.

A semiconductor layer 128 is formed on the gate insulating layer 126 corresponding to the gate electrode 124. Source and drain electrodes 132 and 134 spaced apart from each other and a data line (not shown) connected to the source electrode 132 are formed on the semiconductor layer 128. The data line crosses the gate line to define a pixel region. Although not shown in the figure, the semiconductor layer 128 includes an active layer of intrinsic amorphous silicon and ohmic contact layers of impurity-doped amorphous silicon. The ohmic contact layers may have the same shape as the source and drain electrodes 132 and 134.

Here, the gate electrode 124, the semiconductor layer 128, the source electrode 132 and the drain electrode 134 form a thin film transistor T.

A passivation layer 136 is formed on the source electrode 132, the drain electrode 134 and the data line, and the passivation layer 136 has a drain contact hole 136a exposing the drain electrode 134.

A pixel electrode 138 is formed on the passivation layer 136 in the pixel region and is connected to the drain electrode 134 through the drain contact hole 136a.

A black matrix 142 is formed on an inner surface of the second substrate 140. The black matrix 142 has an opening corresponding to the pixel region and corresponds to the gate line, the data line and the thin film transistor T. A color filter layer 144 is formed on the black matrix 142 and on the inner surface of the second substrate 140 exposed through the opening of the black matrix 142. Although not shown in the figure, the color filter layer 144 includes red, green and blue color filters, each of which corresponds to one pixel region. The red, green and blue color filters are sequentially and repeatedly disposed along a horizontal direction of the display panel 120 as shown in FIG. 5. The same color filters are disposed along the vertical direction of the display panel 120 in the context of the figure. A transparent common electrode 146 is formed on the color filter layer 144.

Meanwhile, although not shown in the figure, an overcoat layer may be formed between the color filter layer 144 and the common electrode 146 to protect the color filter layer 144 and to flatten a surface of the second substrate 140 including the color filter layer 144.

The liquid crystal layer 148 is disposed between the pixel electrode 138 of the first substrate 122 and the common electrode 146 of the second substrate 140. Although not shown in the figure, alignment layers, which determine initial arrangements of liquid crystal molecules, are formed between the liquid crystal layer 148 and the pixel electrode 138 and between the liquid crystal layer 148 and the common electrode 146, respectively.

Even though, in this embodiment, the pixel electrode 138 and the common electrode 146 are formed on the first and second substrates 122 and 140, respectively, both the pixel electrode 138 and the common electrode 146 may be formed on the first substrate 122.

In the meantime, a first polarizer 152 is disposed on an outer surface of the first substrate 122, and a second polarizer 150 is disposed on an outer surface of the second substrate 140. The first and second polarizers 152 and 150 transmit linearly polarized light, which is parallel to their transmission axes. The transmission axis of the first polarizer 152 is perpendicular to the transmission axis of the second polarizer 150. Adhesive layers may be disposed between the first substrate 122 and the first polarizer 152 and between the second substrate 140 and the second polarizer 150.

Although not shown in the figure, a backlight unit is disposed under the first polarizer 152 to provide light to the display panel 120.

Here, a liquid crystal panel is used as the display panel 120. Alternatively, an organic electroluminescent display panel may be used as the display panel 120. In this case, the first polarizer 152 may be omitted, and a λ/4 plate (quarter wave plate: QWP) and a linear polarizer may be used in place of the second polarizer 150.

A patterned retarder 160 is attached on the second polarizer 150. The patterned retarder 160 includes a first base film 162, a retarder layer 164 and an adhesive layer 168. The retarder layer 164 includes left-eye retarders Rl and right-eye retarders Rr, which are alternately arranged along a vertical direction of the device. The adhesive layer 168 contacts the second polarizer 150, and the retarder layer 164 is disposed between the first base film 162 and the second polarizer 150. Here, the positions of the retarder layer 164 and the first base film 162 may be changed. That is, the adhesive layer 168, which contacts the second polarizer 150, is formed on a first surface of the first base film 162, and the retarder layer 164 is formed on a second surface of the first base film 162.

The first base film 162 may be formed of tri-acetyl cellulose (TAC) or cyclo olefin polymer (COP).

The left-eye retarders Rl and the right-eye retarders Rr may have a retardation value of λ/4, and their optical axes may make angles of +45 degrees and −45 degrees with respect to a polarized direction of the linearly polarized light transmitted through the second polarizer 150 from the display panel 120.

A lenticular lens film 170 is disposed on the patterned retarder 160. The lenticular lens film 170 includes a second base film 172 and lenticular lenses 174. Although not shown in the figure, the base film 172 may be attached to the patterned retarder 160 with an adhesive layer.

The second base film 172 may be formed of polyethylene terephthalate (PET) or tri-acetyl cellulose (TAC). Since PET may cause a change in polarization due to birefringence. TAC, beneficially, is used for the second base film 172. The second base film 172 has a thickness of about 60 μm to about 80 μm.

The first base film 162 of the patterned retarder 160 may be omitted. In this case, the retarder layer 164 may be formed on an upper surface of the second polarizer 150 or may be formed on a lower surface of the second base film 172.

A lens pitch P_{L} of the lenticular lens film 170, which is defined as a width of each lenticular lens 174 is smaller than a pixel pitch P_{P} of the display panel 120, which is defined as a distance from an upper end of a pixel to an upper end of a next pixel along the vertical direction of the display panel 120 in the context of FIG. 5 and corresponds to a width of the left-eye retarder Rl or the right-eye retarder Rr of the patterned retarder 160. This is why the attaching tolerance AT is determined considering the error generated in the attaching process of the lenticular lens film 170.

In the meantime, a thickness d of the lenticular lens 174 varies depending on a focal length due to a radius of curvature, and also, the maximum viewing angle changes depending on the focal length of the lenticular lens 174. A 3D crosstalk value can be predicted from an angle of light coming through the lenticular lens 174, and thus the maximum viewing angle can be determined.

For instance, in a 47 inch three-dimensional image display device, when the pixel pitch P_{P} is 541 micrometers and the increasing rate of the front crosstalk is intentionally further increased by about 3%, the attaching tolerance AT may be about 16 micrometers according to the equation (1), and the lens pitch P_{L} may be about 525 micrometers. At this time, the thickness d of the lenticular lens 174 may be within a range of about 20 μm to about 200 μm.

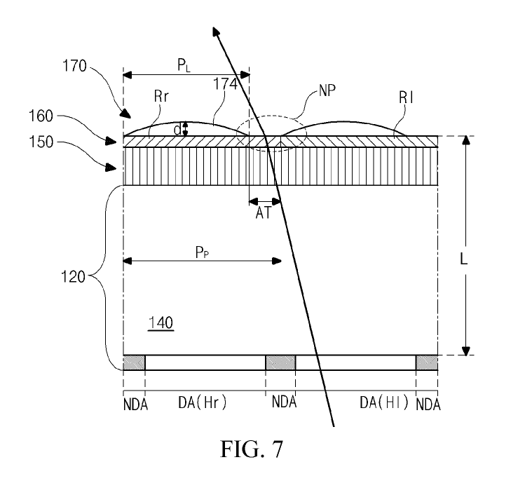

FIG. 7 is a schematic view of showing front 3D crosstalk in a three-dimensional image display device according to an exemplary embodiment of the present invention.

In FIG. 7, the lens pitch P_{L} of the lenticular lens 174 is smaller than the pixel pitch P_{P}. Particularly, the lens pitch P_{L} is smaller than the pixel pitch P_{P} by the attaching tolerance AT.

That is, the attaching error is compensated by setting the attaching tolerance AT. The lens pitch P_{L} is set to be smaller than the pixel pitch P_{P} by the attaching tolerance AT, and each lenticular lens 174 can be disposed over the left-eye retarder Rl or the right-eye retarder Rr. Therefore, the increasing rate of the front crosstalk of the present invention has a smaller value than the increasing rate of the front crosstalk due to the attaching error.

Accordingly, the left-eye image displayed by the left-eye horizontal pixel line Hl and passing through the right-eye retarder Rr does not pass through the lenticular lens 174 in a portion NP, does not come out to the front, and is not transmitted to the viewer. On the other hand, the left-eye image display by the left-eye horizontal pixel line Hl and passing through the left-eye retarder Rl passes through the lenticular lens 174 and is transmitted to the viewer.

From this, the increasing rate of the front crosstalk can be lowered in comparison to the case that the lenticular lens 174 is not accurately attached.

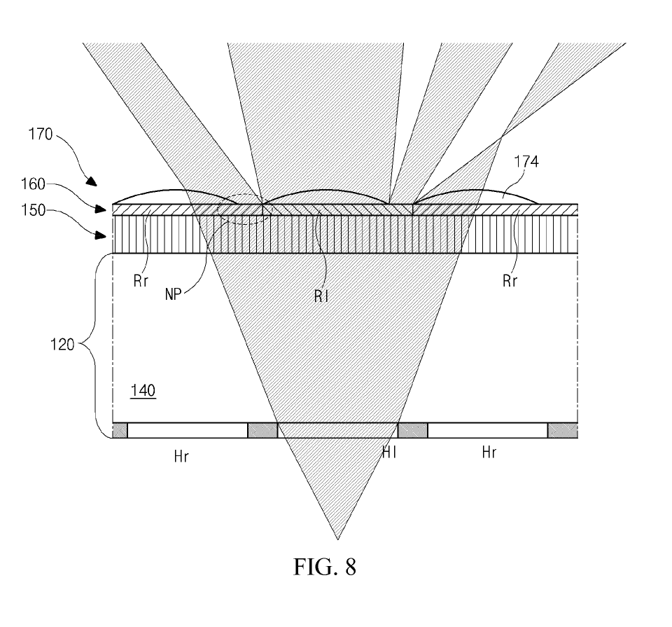

FIG. 8 is a view of showing simulation results of light coming out when the lens pitch P_{L} is smaller than the pixel pitch P_{P}.

In FIG. 8, the left-eye image displayed by the left-eye horizontal pixel line Hl and passing through the right-eye retarder Rr does not pass through the lenticular lens 174 in the portion NP, does not come out to the front, and is not transmitted to the viewer. On the other hand, the left-eye image display by the left-eye horizontal pixel line Hl and passing through the left-eye retarder Rl passes through the lenticular lens 174 and is transmitted to the viewer.

As mentioned above, the lens pitch PL is smaller than the pixel pitch PP in the embodiment of the present invention, and the front crosstalk due to the error in the attaching process is improved.

Thus, the superprecision operation of attaching each lenticular lens 174 of the lenticular lens film 170 to the corresponding left-eye retarder Rl or the corresponding right-eye retarder Rr can be easily done, and the productivity is increased.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An image display device, comprising:
a display panel including left-eye horizontal pixel lines displaying a left-eye image and right-eye horizontal pixel lines displaying a right-eye image;
a polarizing film disposed over the display panel, wherein the polarizing film linearly polarizes the left-eye image and the right-eye image;
a patterned retarder disposed over the polarizing film and including left-eye retarders and right-eye retarders; and
a lenticular lens film disposed over the polarizing film and including lenticular lenses, wherein the lenticular lenses correspond to the left-eye retarders and the right-eye retarders, respectively,
wherein the lenticular lenses are spaced part from each other.

2. The device according to claim 1, wherein a lens pitch of the lenticular lenses is smaller than a pixel pitch by an attaching tolerance, wherein the pixel pitch is defined as a distance from an upper end of one of adjacent left- and right-eye horizontal pixel lines to an upper end of the other of the adjacent left- and right-eye horizontal pixel lines.

3. The device according to claim 2, wherein the attaching tolerance is determined by a product of an increasing rate of an applicable front crosstalk and the pixel pitch.

4. The device according to claim 1, wherein a sum of the attaching tolerance and the lens pitch is the pixel pitch.

5. The device according to claim 1, wherein a thickness of the lenticular lenses is within a range of about 20 micrometers to about 200 micrometers.

6. The device according to claim 1, wherein the patterned retarder is disposed between the polarizing film and the lenticular lens film.

7. The device according to claim 1, wherein the lenticular lens film further includes a base film adjacent to the patterned retarder, and the base film includes tri-acetyl cellulose.

8. The device according to claim 1, wherein the left-eye retarders correspond to the left-eye horizontal pixel lines and change the linearly polarized left-eye image into left-circularly polarized image, and the right-eye retarders correspond to the right-eye horizontal pixel lines and change the linearly polarized right-eye image into right-circularly polarized image.
